(19) United States
(12) Patent Application Publication
(10) Pub. No.: US 2013/0159008 A1
(43) Pub. Date: Jun. 20, 2013

(54) SYSTEMS AND METHODS FOR VERIFYING HEALTHCARE VISITS

(71) Applicants: Jonathan Mills, Loveland, OH (US); Thomas M. Rempe, Wyoming, OH (US); Chuck Eliasen, Cincinnati, OH (US); Anish Bole, Dayton, OH (US); Robyn M. Andersen, Omaha, NE (US); Valerie Stribbling, Atlanta, GA (US)

(72) Inventors: Jonathan Mills, Loveland, OH (US); Thomas M. Rempe, Wyoming, OH (US); Chuck Eliasen, Cincinnati, OH (US); Anish Bole, Dayton, OH (US); Robyn M. Andersen, Omaha, NE (US); Valerie Stribbling, Atlanta, GA (US)

(73) Assignee: FIRST DATA CORPORATION, Greenwood Village, CO (US)

(21) Appl. No.: 13/331,745

(22) Filed: Dec. 20, 2011

(51) Int. Cl. G06Q 50/22

(52) U.S. Cl. 705/2

(57) ABSTRACT

Embodiments of the invention provide systems and method for verifying healthcare visits. Location verification information may be received from a portable device by a verification system that includes one or more computers. The portable device may be associated with an individual directed to provide a healthcare service to a patient during a healthcare visit, and the location verification information may be collected by the portable device. The verification system may compare at least a portion of the received information to stored information associated with the patient. Based at least in part upon the comparison, the verification system may determine whether the healthcare visit was performed at an approved service location for the patient.

### FIELD OF THE INVENTION

Embodiments of the invention relate generally to the verification of the presence of a person at a selected location, and more specifically to the verification of the presence of a healthcare representative at a healthcare visit.

### BACKGROUND OF THE INVENTION

Certain types of healthcare services, such as home nursing services, are provided at a patient or customer location. For example, home or community visits (e.g., assisted living center visits, nursing home visits, etc.) are performed in order to provide a wide variety of different healthcare services. With healthcare services provided at a patient location, it is often desirable to confirm that a visit has actually taken place. Such visit verification may assist in preventing billing abuse by healthcare providers.

Several conventional techniques for verifying a visit have been developed. In one conventional system, a healthcare representative, upon arrival for a visit, uses a patient's telephone to call a verification telephone service. When the call is received, the Dialed Number Identification System (“DNIS”) and the Automated Number Identification (“ANI”) are detected. These numbers are then compared to stored patient information in order to verify that the healthcare visit has taken place. However, many patient locations do not have a telephone that enables a healthcare representative to dial a verification service. Additionally, as the use of cellular technology increases, the verification of a DNIS and/or ANI cannot be relied upon to accurately verify the location of a healthcare representative.

Another conventional verification technique involves the distribution of electronic fobs to patients. The electronic fobs randomly generate codes that are recorded by a healthcare representative during a visit. The recorded codes are then provided by the healthcare representative to a verification system, and the verification system compares the recorded codes to a stored copy of the codes that are output by the electronic fobs. However, the distribution of electronic fobs to patients may be relatively expensive. Additionally, the manual recording of codes is subject to human error that can result in improper verification determinations. Further, verification errors may occur if synchronization between the electronic fobs and the verification system is compromised.

Additionally, conventional verification techniques do not facilitate the verification of healthcare services and procedures that are provided to patients. As a result, healthcare services may be performed that are not authorized or covered by a payor such as an insurance provider. Accordingly, there is an opportunity for improved systems and methods for verifying healthcare visits.

### BRIEF DESCRIPTION OF THE INVENTION

Embodiments of the invention may provide systems and methods for verifying healthcare visits. According to one example embodiment of the invention, a method for verifying healthcare visits is provided. Location verification information may be received from a portable device by a verification system that includes one or more computers. The portable device may be associated with an individual directed to provide a healthcare service to a patient during a healthcare visit, and the location verification information may be collected by the portable device. The verification system may compare at least a portion of the received information to stored information associated with the patient. Based at least in part upon the comparison, the verification system may determine whether the healthcare visit was performed at a service location for the patient.

According to another embodiment, a system for verifying healthcare visits may be provided. The system may include at least one memory and at least one processor. The at least one memory may be configured to store computer-executable instructions. The at least one processor may be configured to access the at least one memory and execute the computer-executable instructions to: receive, from a portable device associated with an individual directed to provide a healthcare service to a patient, location verification information collected by the portable device; compare at least a portion of the received information to stored information associated with the patient; and determine, based at least in part upon the comparison, whether the healthcare visit was performed at a service location for the patient.

According to yet another embodiment of the invention, one or more computer-readable media may be provided. The one or more computer-readable media may store computer-executable instructions that, when executed by at least one processor, configure the at least one processor to perform operations comprising: identifying location verification information on behalf of a portable device carried by an individual who provides a healthcare service to a patient during a healthcare visit; and directing communication of the location verification information to a verification system. The verification system may evaluate at least a portion of the location verification information to determine whether the healthcare visit was performed at an approved service location for the patient.

According to yet another embodiment of the invention, a portable device may be provided. The portable device may be associated with an individual who provides a healthcare service to a patient during a healthcare visit. The portable device may include at least one memory and at least one processor. The at least one memory may be configured to store computer-executable instructions. The at least one processor may be configured to access the at least one memory and execute the computer-executable instructions to: identify location verification information on behalf of the portable device; and direct communication of the location verification information to a verification system. The verification system may evaluate at least a portion of the location verification information to determine whether the healthcare visit was performed at an approved service location for the patient.

Additional systems, methods, apparatus, features, and aspects are realized through the techniques of various embodiments of the invention. Other embodiments and aspects of the invention are described in detail herein and are considered a part of the claimed invention. Other advantages and features can be understood with reference to the description and to the drawings.

### BRIEF DESCRIPTION OF THE DRAWINGS

FIG. 1 illustrates a block diagram of an example system that may be utilized to facilitate healthcare visit verification, according to an illustrative embodiment of the invention.

FIG. 2 illustrates a flow diagram of an example process for providing a verification service in association with a healthcare visit, according to an example embodiment of the invention.

FIG. 3 illustrates flow diagrams of example processes for performing a location verification for a healthcare visit, according to an example embodiment of the invention.

FIG. 4 illustrates a flow diagram of an example process for identifying a location associated with a patient, according to an example embodiment of the invention.

FIG. 5 illustrates a flow diagram of an example process for collecting and processing healthcare visit information by a portable device, according to an example embodiment of the invention.

### DETAILED DESCRIPTION OF THE INVENTION

Various embodiments of the invention are directed to the verification of healthcare visits, such as healthcare visits that are performed by a healthcare representative at a patient location. In certain embodiments, a healthcare representative may utilize a portable device, such as a mobile device or a tablet computer, to collect location verification information at a patient location. A wide variety of suitable information may be collected at a patient location, including but not limited to, global positioning system (“GPS”) coordinates, information read from a patient card or other patient device (e.g., account numbers, quick response (“QR”) codes or matrix barcodes, etc.), and/or information (e.g., account numbers, authentication codes, dynamic authentication codes, etc.) received via a communications session with a patient device (e.g., a patient mobile device, a patient computer, etc.). Following the collection of location verification information, at least a portion of the location verification information may be communicated to a verification system for evaluation. in certain embodiments, the type of information that is collected may be determined based upon the network connectivity between the portable device and the verification system. For example, if a network connection can be established while the portable device is at the patient location, then GPS coordinates may be collected and communicated. If, however, a network connection cannot be established while the portable device is at the patient location, then information may be collected from a patient device, and at least a portion of the collected information may be subsequently communicated to the verification system once a network connection can be established. As desired in other embodiments, both GPS coordinates and information collected from a patient device may be communicated to a verification system.

In certain embodiments, a service application (or a plurality of applications) may be stored on the portable device, and the service application may facilitate the collection of location verification information and the communication of the location verification information to the verification system. Additionally, in certain embodiments, the service application may be configured to receive a wide variety of information from the verification system. For example, the service application may be configured to receive appointment information (e.g., patient names, appointment locations, appointment times, etc.) from the verification system prior to a healthcare representative visiting the patient location. As another example, the service application may be configured to receive healthcare services information from the verification system. in certain embodiments, the healthcare services information may include information associated with healthcare services scheduled for the patient and/or information associated with healthcare services that have been approved with respect to the patient (e.g., healthcare services that are covered by a suitable healthcare payer, etc.). As desired, the service application may process the received healthcare services information in order to generate one or more graphical user interfaces (or other suitable outputs) that are presented to the healthcare representative. For example, during a healthcare visit, the service application may only allow the healthcare representative to view information associated with approved services and/or enter claim information associated with approved services.

Additionally, in certain embodiments of the invention, location verification information and healthcare service information may be stored by the service application and/or the portable device. For example, information may be stored in the event that a communications session cannot be established with the verification system. As desired in certain embodiments, at least the healthcare-related information (e.g., patient information, healthcare services information, etc.) may be stored in a secure manner. For example, the stored information may be encrypted. Additionally, in the event that a communications session cannot be established between the portable device and the verification system within a threshold period of time (e.g., one day, etc.), then additional security measures may be taken by the service application. For example, access to the stored information may be locked. As another example, at least a portion of the stored information may be deleted.

The verification system may be configured to receive location verification information and, as desired, timing information from any number of portable devices. Additionally, the verification system may be configured to evaluate the received information in order to determine whether one or more healthcare visits and/or healthcare services were performed at approved service locations associated with patients. For example, the verification system may be configured to evaluate received GPS coordinates and/or information collected by a portable device from a patient device. As desired, at least a portion of the received location verification information may be compared to stored information associated with a patient, and a determination may be made as to whether a correspondence exists. In this regard, a determination may be made as to whether a healthcare visit and/or service was performed at an approved service location for the patient. Additionally, in certain embodiments, received timing information may be compared to appointment information associated with the patient in order to determine whether a healthcare visit and/or service was performed at an appropriate point in time.

In certain embodiments, the verification system may also be configured to provide a copy of the service application to any number of portable devices, although other distribution channels may be utilized. Additionally, as desired, the verification system may be configured to provide appointment information and/or information associated with available and/or approved healthcare services to the portable device. Further, the verification system may be configured to receive information associated with performed healthcare services from a portable device. In this regard, the verification system may determine whether the performed services are approved services and, in the event that the performed services are approved (and determined to be performed at an approved service location and/or during an appropriate time period), the verification system may approve the generation of a healthcare claim transaction associated with the performed healthcare services.

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

System Overview

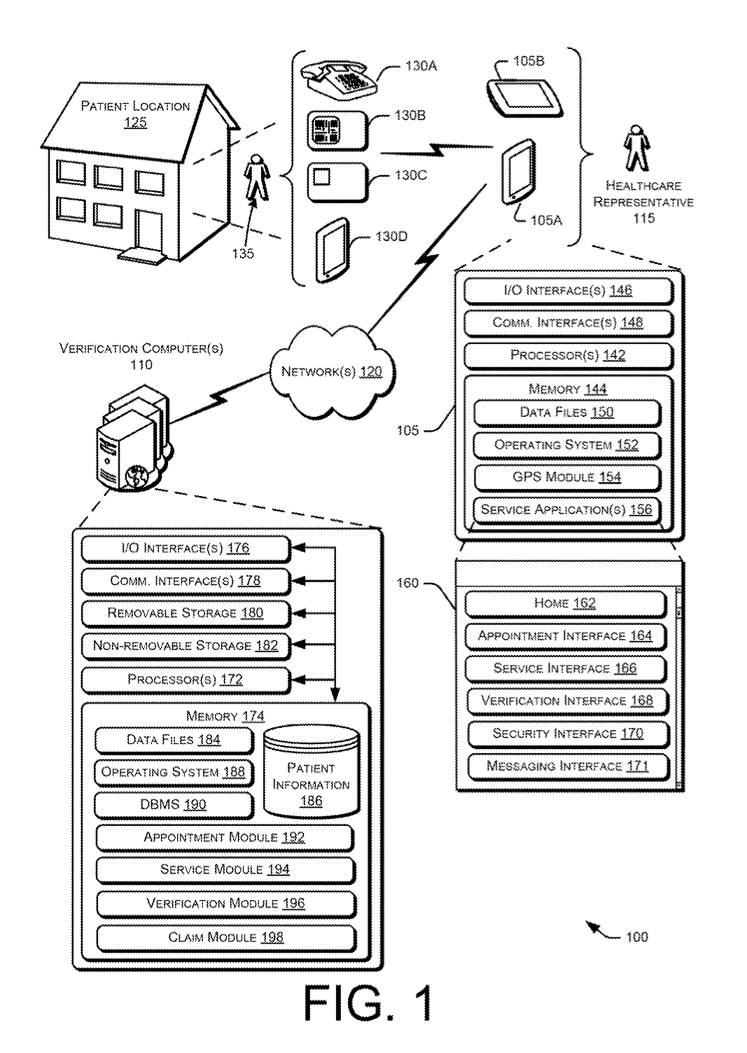

FIG. 1 illustrates a block diagram of an example system 100 that may be utilized to facilitate healthcare visit verification, according to an illustrative embodiment of the invention. As shown in FIG. 1, the system may include any number of portable devices, such as the illustrated portable devices 105A, 105B, and/or any number of verification computers 110. A portable device (generally referred to as portable device 105) may be associated with a healthcare representative 115, such as a nurse, physical therapist, or other individual who provides healthcare services to patients at patient locations. Additionally, any number of suitable networks, such as the illustrated networks 120, may facilitate communication between the portable devices 105A, 105B and the verification computer 110. Each of these components is discussed in further detail.

According to an aspect of the invention, a healthcare representative 115 may carry a portable device 105 to a patient location 125 in association with a healthcare visit. While at the patient location 125, the portable device 105 may be utilized to collect a wide variety of different information, such as location verification information, timing information (e.g., a start time for a visit, an end time for the visit, etc.), and/or information associated with performed healthcare services. In certain embodiments, the portable device 105 may collect information (e.g., location verification information, etc.) from one or more suitable patient device associated with a patient 135, such as a patient card 130B that includes a quick response (“QR”) code, a patient card 130C that includes a radio frequency (“RF”) or near field communication (“NFC”) chip, a patient mobile device 130D, a patient tablet computer, a patient computer, or any other suitable patient device. At least a portion of the collected information may then be communicated by the portable device 105 to one or more verification computers 110 in order to facilitate a visit verification.

With reference to FIG. 1, any number of portable devices may be utilized as desired in various embodiments of the invention. The illustrated example portable devices include a mobile device 105A (e.g., a mobile phone, a personal digital assistant, etc.) and a tablet computer 105B; however, other types of portable devices may be utilized as desired, such as a laptop computer. A healthcare representative 115 may utilize a portable device (generally referred to as portable device 105) to collect location verification information at a patient location 125. At least a portion of the collected information, as well as timing information and/or healthcare services information, may then be communicated to the verification computers 110. Additionally, in certain embodiments, a portable device may be utilized to receive a wide variety of information from the verification computers 110 (or other data sources), such as appointment information and/or information associated with approved healthcare services that may be performed during various healthcare visits.

An example portable device 105 will now be described. The portable device 105 may be a suitable processor-driven device that facilitates the collection and processing of location verification information. Additionally, the portable device 105 may be a suitable processor-driven device that facilitates the receipt and processing of information (e.g., appointment information, healthcare services information, etc.) from the verification computers 110 (or other devices). As such, the portable device 105 may include any number of suitable computing devices, such as a personal computer, a digital assistant, a personal digital assistant, a digital tablet, an Internet appliance, an application-specific circuit, a microcontroller, a minicomputer, and/or any other processor-based device. The execution of suitable computer-implemented instructions or computer-executable instructions by the portable device 105 may form a special purpose computer or other particular machine that is operable to facilitate the collection and processing of location verification information and/or the receipt and processing of information associated with healthcare visits to be carried out by the healthcare representative 115.

With reference to FIG. 1, the portable device 105 may include one or more processors 142, one or more memory devices 144, one or more input/output (“I/O”) interfaces 146, and/or one or more communication or network interfaces 148. The processors 142 may be configured to execute any number of software applications and/or computer-readable or computer-executable instructions. The memory devices 144 may include any number of suitable memory devices, such as caches, read-only memory devices, random access memory devices, flash memory devices, magnetic storage devices, removable storage devices (e.g., memory cards, etc.), and/or other memory devices. As desired, the memory devices 144 may include internal memory devices and/or external memory devices in communication with the portable device 105. Additionally, in certain embodiments, the memory devices 144 may include any number of secure data elements (e.g., secure integrated circuits, secure chips, etc.) that are in communication with other processing components of the portable device 105. The memory devices 144 may store data, executable instructions, and/or various program modules utilized by the processors 142. Examples of data that may be stored by the memory devices 144 include data files 150 and/or any number of suitable program modules and/or applications that may be executed by the processors 142, such as an operating system (“OS”) 152, a GPS module 154, and/or any number of service applications 156 or service modules.

The data files 150 may include any suitable data that facilitates the operation of the portable device 105, the receipt of information associated with healthcare visits to be carried out (e.g., appointment information, approved healthcare services information, etc.), the collection of location verification information, the collection of timing information, the collection of information associated with performed healthcare services, communication with one or more patient devices, and/or communication with one or more verification computers 110. For example, the data files 150 may include, but are not limited to, appointment information, information associated with approved healthcare services that may be provided to one or more patients, collected location verification information (e.g., collected GPS coordinates, information collected from one or more patient devices, etc.), timing information associated with healthcare visits, patient identification information, and/or information associated with performed healthcare services.

The OS 152 may be a suitable software module that controls the general operation of the portable device 105. For example, the OS 152 may be, but is not limited to, Microsoft Windows®, Apple OSX™, Unix, a mobile operating system, or a specially designed operating system. The OS 152 may also facilitate the execution of other software modules, for example, the GPS module 154 and/or the service applications 156. The GPS module 154 may facilitate the collection of GPS coordinates associated with the portable device 105. For example, the GPS module 154 may direct a suitable transceiver or other GPS element associated with the portable device 105 to establish communication with a GPS satellite network. In this regard, GPS coordinates associated with the portable device 105 may be determined by the GPS module 154.

As desired, any number of service applications 156 or service modules may be provided. A service application 156 may be a suitable software module or application that facilitates the identification and/or collection of location verification information at a patient location 125 and the communication of at least a portion of the location verification information and, as desired, timing information and/or healthcare services information, to one or more verification computers 110. Additionally, the service application 156 may facilitate the receipt of a wide variety of information (e.g., appointment information, approved healthcare services information, etc.) from any number of data sources, such as the verification computers 110. Further, the service application 156 may be configured to generate and direct the presentation of a wide variety of interfaces to the healthcare representative 115 via the portable device 105.

In certain embodiments of the invention, a service application 156 may be a special purpose application that is provisioned to (e.g., over the air provisioning, etc.), downloaded to, and/or otherwise provided to a portable device 105. For example, the service application 156 may be provided to the portable device 105 by the verification computers 110, by a healthcare service provider computer (e.g., a computer associated with a healthcare service provider that employs or contracts with the healthcare representative 115, etc.), or by a third-party service provider computer (e.g., an application store computer, etc.). The service application 156 may include computer-executable instructions that, when stored on a suitable memory device, form one or more computer-readable media configured to facilitate the provision of a visit verification service. The computer-readable media may be formed on a wide variety of memory devices, such as the portable device 105 and/or any number of systems and/or devices that facilitate the distribution of the service application 156 to the portable device, such as the verification computers 110, the healthcare service provider computer, and/or the third-party service provider computer.

In operation, the service application 156 may establish communication with the verification computers 110, and the service application 156 may receive data associated with healthcare services or healthcare visits, such as patient appointment information and/or information associated with available or approved healthcare services that may be performed at the various appointments. In certain embodiments, appointment and/or available services information may be received prior to the healthcare representative 115 visiting the patient location 125. In other embodiments, the information may be received when the service application 156 is activated at the patient location 125.

A wide variety of suitable communication methods and/or techniques may be utilized to establish communication with the verification computers 110. For example, one or more Web sites (e.g., secure Web sites, etc.) hosted by and/or associated with the verification computers 110 may be accessed by the service application 156. Upon accessing and being authenticated by a suitable Web site or other hosted site, a network “super session” may be established between the service application 156 and the verification computers 110. Additionally, the verification computers 110 may communicate a session identifier and encryption information (e.g., an encryption token, an encryption key, etc.) to the service application 156. The encryption information may be utilized to encrypt any information, such as protected healthcare information (e.g., patient information, healthcare services information, etc.), that is stored locally on the portable device 105. Additionally, a “super session” may be a communications session that persists even when network connectivity is not available between the portable device 105 and the verification computers 110. For example, a “super session” may be established to be maintained for a predetermined period of time, such as eighteen (18) hours or twenty-four (24) hours. In this regard, the portable device 105 may be moved so that it goes in and out of areas that have network connectivity (e.g., cellular coverage, etc.). When network connectivity exists, the “super session” may facilitate the communication of collected data (e.g., location verification information, protected healthcare information, etc.) to the verification computers (e.g., substantially real-time communication, near-real-time communication, batch file communication, etc.). However, when connectivity does not exist, collected data may be stored for subsequent communication with at least a portion of the data (e.g., protected healthcare information, etc.) being encrypted prior to storage by utilizing the encryption information.

Additionally, in certain embodiments of the invention, the service application 156 may provide a platform via which secure messages may be communicated to the portable device 105. For example, healthcare messages and/or instruction messages may be communicated to the service application 156 via the verification computers 110 (or another device capable of establishing a secure communications session with the service application 156). Using the verification computers 110 as an example of a device that drives messages to the service application 156, the verification computer 110 may generate one or more messages and/or receive one or more messages from other entities, such as a healthcare provider. The one or more messages may then be pushed or otherwise provided (e.g., provided upon request, etc.) to the portable device 105 for presentation via the service application 156. For example, one or more messages may be communicated to the portable device 105 when network connectivity exists between the portable device 105 and the verification computers 110. Additionally, in certain embodiments, a suitable alert message, such as a short message service (“SMS”) message, may be communicated to the portable device 105 to alert the healthcare representative that messages are available for download and/or available within the service application 156. In this regard, the healthcare representative may access the service application 156 in order to receive any number of secure messages, such as messages that include protected healthcare information.

At the patient location 125, the healthcare representative 115 may activate the service application 156 (or an established “super session”), and the service application 156 may attempt to establish communication with the verification computers 110. In certain embodiments, different location verification information may be identified depending on whether a communication sessions can be established and/or whether network connectivity (e.g., mobile coverage, etc.) exists for the portable device 105. For example, if communication is established and/or network connectivity exists (e.g., cellular coverage, satellite coverage, etc.), then the service application 156 may direct the GPS module 154 to determine GPS coordinates that are provided by the service application 156 to the verification computers 110 along with timing information and/or information associated with performed healthcare services. In certain embodiments, a plurality of GPS coordinates may be identified at different points in time. For example, GPS coordinates may be identified at the start of a visit, at the end of the visit, and at any number of periodic points in time (e.g., every five minutes, every few minutes, etc.) during the visit. In this regard, the various coordinates and associated timing information (e.g., time stamps, etc.) may be evaluated by the verification computers 110 in order to determine whether the healthcare representative remained at the patient location 125 for the duration of an appointment. Accordingly, situations in which a healthcare representative checks in at the beginning of a scheduled visit, leaves, and then returns to check in at the end of a scheduled visit may be identified.

In certain embodiments, location information for a patient may be received by the service application 156 from the verification computers 110 prior to a healthcare visit. The received location information may include a wide variety of GPS coordinates associated with the patient location 125, such as a single set of GPS coordinates for the patient location 125 or a plurality of coordinates that define the boundaries of the patient location 125 (i.e., a “geo-fence”). During a healthcare visit, the service application 156 may periodically collect GPS coordinates and determine whether the collected coordinates satisfy the received coordinates. For example, the service application 156 may determine whether the collected coordinates are within an acceptable distance of received coordinates. As another example, the service application 156 may determine whether the collected coordinates indicate whether the healthcare representative has traveled outside of a geo-fence or defined boundaries for the patient location 125. Any exceptions may be identified by the service application 156, and information associated with the exceptions may be communicated to the verification computers 110 for processing.

As another example, if communication is not established and/or network connectivity does not exist, then the service application 156 may collect location verification information from one or more patient devices, and the collected information may be stored for subsequent communication to the verification computers 110. As desired, other information may also be stored, such as timing information and/or information associated with performed services. In certain embodiments, at least a portion of the information may be stored in a secure manner. For example, information may be encrypted prior to storage utilizing suitable encryption information, such as encryption information previously received from the verification computers 110. As another example, information may be stored on one or more secure elements.

A wide variety of suitable techniques may be utilized as desired to collect location verification information from a patient device. For example, the service application 156 may direct a camera to capture an image of a QR code from a patient device, and the image may be processed by the service application 156 in order to identify encoded information. As another example, the service application 156 may facilitate RF, NFC, or other communication with a patient device in order to identify location verification information. As yet another example, the service application 156 may facilitate the establishment of a communications session with a patient device (e.g., a mobile device, a personal computer, a tablet computer, etc.), and location verification information (e.g., a code, an account identifier, a key, dynamic authentication information, etc.) may be received via the communications session. Additionally, in certain embodiments, a plurality of different types of information may be collected. For example, if connectivity between the portable device 105 and the verification computers 110 exists, then the service application 156 may collect both GPS coordinates and information from a patient device. As another example, multiple types of information may be collected from one or a plurality of patient devices. Indeed, a wide variety of different types of location verification information and/or combination of information may be collected by the service application 156.

In the event that location verification information and other information (e.g., timing information, performed healthcare services information, etc.) is stored by the service application 156, the service application 156 may attempt to establish communication with the verification computers 110 at a subsequent point in time. For example, connectivity may not be available at the patient location 125; however, when the healthcare representative 115 leaves the patient location 125, the service application 156 or a suitable background component or service associated with the service application 156 may attempt (e.g., periodically attempt, continuously attempt, attempt based upon the identification of mobile coverage, etc.) to establish communication with the verification computers 110. In the event that communication is established, then at least a portion of the stored information may be communicated to the verification computers 110.

If, however, communication cannot be established, a wide variety of safeguards may be taken in order to protect the stored information, which may include patient-specific information subject to privacy laws, such as the Health Insurance Portability and Accountability Act (“HIPAA”). For example, if communication cannot be established within a predetermined period of time (e.g., prior to the expiration of an established “super session,” a predetermined number of hours, etc.) or before a timing threshold is reached, then one or more suitable control actions may be taken to safeguard the stored information. For example, at least a portion of the stored information may be deleted. As another example, access to the stored information may be locked until suitable authentication credentials are entered into or received by the portable device 105 (e.g., provided by the healthcare representative, received from the verification computers 110, etc.). Additionally, as desired, the service application 156 may provide suitable screen lock functionality. For example, if the service application 156 remains open on the portable device 105 for a predetermined period of time (e.g., 10 minutes, etc.) without healthcare representative interaction, then a screen or other display associated with the portable device 105 may be locked until suitable authentication credentials (e.g., a user name and password) are entered and verified.

As desired, a wide variety of interfaces (e.g., graphical user interfaces, etc.) may be generated by the service application 156 and output for presentation to the healthcare representative 115 via one or more suitable output devices associated with the portable device 105. Examples of suitable interfaces include, but are not limited to, a home interface 162, an appointment interface 164, a service interface 166, a verification interface 168, a security interface 170, and/or a messaging interface 171. In one example embodiment, the home interface 162 may provide a wide variety of service application options, such as links or selectable indicators that facilitate access to other interfaces. The appointment interface 164 may present upcoming appointment information, such as patient names, patient addresses, and/or appointment times. As desired, the appointment interface 164 may also facilitate the receipt of information utilized to request future appointments and/or to change appointments. The service interface 166 may facilitate the presentation of available or approved healthcare services for a patient. In certain embodiments, only information associated with pre-approved services may be communicated to the portable device 105 for display via the service interface 166. Additionally, the service interface 166 may facilitate the collection of information associated with healthcare services performed or provided by the healthcare representative. As desired, information associated with services that are not pre-approved may be received, and the service interface 166 may facilitate the receipt of information associated with reasons for which the other services were performed.

The verification interface 168 may facilitate the receipt of location verification information by the service application 156. For example, the verification interface 168 may facilitate the selection of one or more types of location verification information to be collected and/or the receipt of any number of suitable commands that facilitate the collection of the verification information (e.g., commands to read information from a patient device, commands to establish communication with a patient device and/or to receive information from a patient device, etc.). The security interface 170 may facilitate the provision of safeguards and/or protections for stored healthcare information. For example, the security interface 170 may facilitate the entry and receipt of authentication credentials to be verified in the event that access to stored information has been locked. Finally, the messaging interface 171 may facilitate the display of secure messages output by the verification computers 110 and/or other systems, such as healthcare provider systems. For example, the verification computers 110 may receive messages from healthcare providers, and the verification computers 110 may push the messages to the service application 156 for presentation via the messaging interface 171. The interfaces illustrated in FIG. 1 are provided by way of example only, and a wide variety of other interfaces may be provided as desired in various embodiments of the invention.

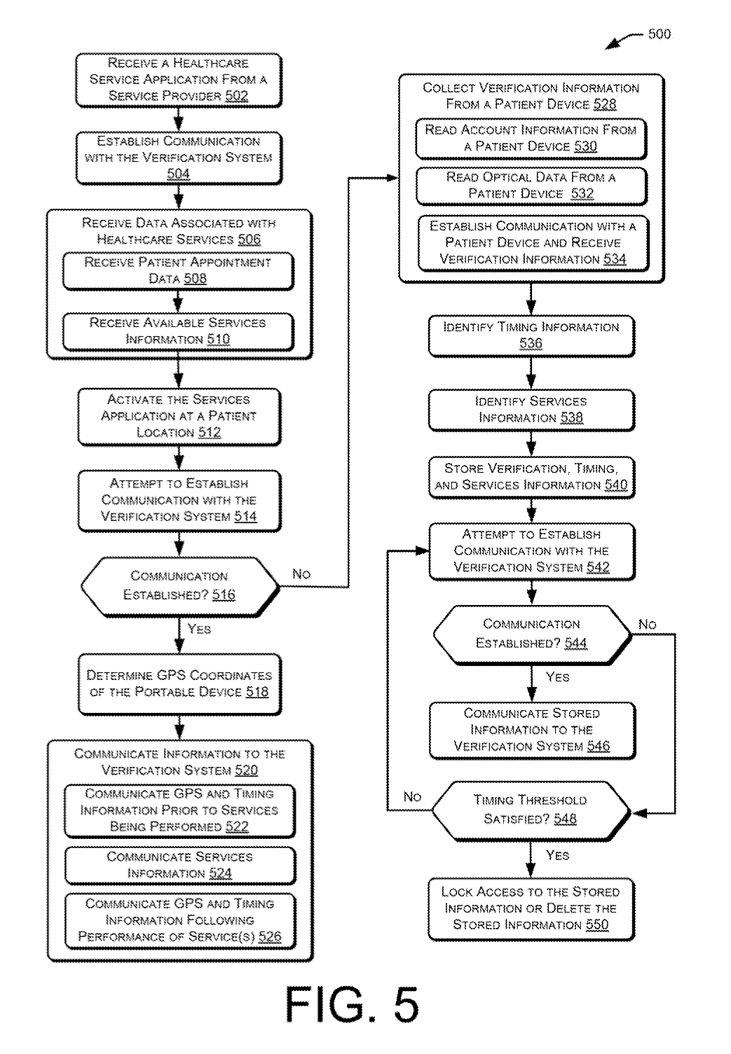

One example of the operations that may be performed by the service application 156 is described in greater detail below with reference to FIG. 5.

With continued reference to the portable device 105, the one or more I/O interfaces 146 may facilitate communication between the portable device 105 and one or more input/output devices, for example, a camera and/or one or more user interface devices, such as a display, keypad, control panel, touch screen display, microphone, speaker, etc., that facilitate user interaction with the customer device 105. In this regard, user commands may be received by the portable device 105. Additionally, certain information, such as QR codes and/or other images, may be collected from a patient card 130B or other patient device.

The one or more communication interfaces 148 may facilitate communication between the portable device 105 and any number of patient devices. In this regard, a wide variety of information, such as location verification information, may be collected from various patient devices. For example, the communication interfaces 148 may facilitate RF and/or NFC communication with a smart chip or other component integrated into a patient card (e.g., a healthcare coverage card, etc.). As another example, the communication interfaces 148 may facilitate network communication with any number of patient devices, such as Bluetooth communication, Wi-Fi communication, and/or local area network communication. Additionally, the communication interfaces 148 may facilitate connection of the portable device 105 to one or more suitable networks, such as networks 120, that facilitate communication with the verification computers 110. The networks 120 may include any number of suitable networks and/or combinations of networks, such as a cellular network, a Wi-Fi enabled network, a Bluetooth-enabled network, the Internet, a suitable wide area network, any number of local area networks, and/or a wide variety of wired and/or wireless networks. In this regard, the portable device 105 may receive information, such as appointment information and/or healthcare services information, from the verification computers 110. Additionally, the portable device 105 may communicate information, such as location verification information, timing information, and/or provided healthcare service information, to the verification computers 110.

With continued reference to FIG. 1, any number of verification computers 110 may be provided as desired in various embodiments. A verification computers 110 may include any number of suitable processor-driven devices that facilitate the verification of healthcare visits and/or the provision of healthcare visit information (e.g., appointment information, approved/available healthcare services information, etc.) to portable devices. For example, the verification computers 110 may include a server computer, a mainframe computer, one or more networked computers, a desktop computer, a personal computer, a laptop computer, a mobile computer, or any other processor-based device. The verification computers 110 may utilize one or more processors 172 to execute computer-readable or computer-executable instructions to facilitate the operations of the verification computers 110. As a result of executing these computer-executable instructions, a special purpose computer or particular machine may be formed that facilitates the verification of healthcare visits and, as desired, the distribution of healthcare visit information.

An example verification computer 110 will now be described. In addition to having one or more processors 172, the verification computer 110 may further include one or more memory devices 174, one or more input/output (“I/O”) interface(s) 176, and/or one or more communication interface(s) 178. The memory devices 174 may include any number of suitable memory devices, such as caches, read-only memory devices, random access memory devices, flash memory devices, magnetic storage devices, removable storage devices 180 (e.g., memory cards, etc.), and/or non-removable storage devices 182. As desired, the memory devices 174 may include internal memory devices and/or external memory devices in communication with the verification computer 110. The memory devices 174 may store data, executable instructions, and/or various program modules utilized by the processors 172. Examples of data that may be stored by the memory devices 174 include data files 184, any number of databases and/or other memory constructs, such as one or more patient information databases 186, and/or any number of suitable program modules and/or applications that may be executed by the processors 172, such as an operating system (“OS”) 188, a database management system (“DBMS”) 190, an appointment module 192, a service module 194, a verification module 196, and/or a claim module 198.

The data files 184 may include any suitable data that facilitates the operation of the verification computer 110 and/or the interaction of the verification computer 110 with one or more other components of the system 100. For example, the data files 184 may include, but are not limited to, information that facilitates the identification of portable devices, information that facilitates communication with portable devices, information that facilitates the identification of appointments, information that facilitates the determination of available or approved services, received location verification information, information that facilitates location verification determinations, information that facilitates healthcare service reviews, and/or information that facilitates the approval and/or generation of healthcare claims and/or healthcare claim transactions. The patient information database 186, which may include any number of internal and/or external databases, may store a wide variety of information associated with various patients. Examples of suitable information that may be stored in the patient information database 186 include, but are not limited to, patient identification information, patient healthcare information, patient insurance and/or coverage information, information associated with healthcare providers and/or healthcare representatives that provide services to various patients, patient location information, patient location verification information, information utilized to generate authentication information for a location verification, information associated with patient appointments, and/or information associated with approved or available services that may be performed for a patient. A wide variety of other types of information may be stored as desired in the data files 184 and/or the patient information database 186.

The OS 188 may be a suitable module that facilitates the general operation of the verification computer 110, as well as the execution of other program modules. For example, the OS 188 may be, but is not limited to, Microsoft Windows®, Apple OSX™, Unix, a mainframe computer operating system (e.g., IBM z/OS, MVS, OS/390, etc.), or a specially designed operating system. The DBMS 190 may be a suitable program module that facilitates management of the data files 184, data stored in the memory 174, and/or data stored in the patient information database 186, and/or information stored in any number of other suitable databases.

The appointment module 192 may be a suitable software module or application that facilitates the communication of appointment information to any number of portable devices. In operation, communication may be established between a portable device 105 and the verification computer 110, and a request for appointment information may be received. A wide variety of information may be included in the request, such as identification information for the portable device 105 (e.g., a device identifier, a cellular telephone number, etc.) and/or identification information for the healthcare representative 115 (e.g., a representative name, a representative identification number, etc.). The appointment module 192 may identify appointment information for the healthcare representative 115, and the appointment module 192 may direct the communication of the appointment information to the portable device 105. Examples of suitable appointment information include, but are not limited to, patient names, patient addresses or locations, appointment times, and/or scheduled services or procedures to be performed.

The service module 194 may be a suitable software module or application that facilitates the provision of available and/or approved healthcare services information to a portable device 105. Additionally, the service module 194 may facilitate the evaluation of information associated with services performed during a healthcare visit. In operation, the service module 194 may receive a request to identify one or more healthcare services approved or available for provision to a patient during a healthcare visit. The service module 194 may then evaluate a wide variety of information to identify the approved or available healthcare services. For example, the service module 194 may identify one or more healthcare payors (e.g., insurance companies, government payors, etc.) for a patient, and the service module 194 may determine the scope of coverage provided by the payors to the patient. As desired, the service module 194 may additionally identify a healthcare provider (e.g., a nursing service, etc.) associated with the healthcare representative 115, and the service module 194 may determine or identify one or more services offered by the healthcare provider that are covered by the one or more payors. Once one or more available and/or approved healthcare services have been identified, information associated with the services may be communicated to the portable device 105. In certain embodiments, a service application 156 associated with the portable device 105 may process the received information in order to generate one or more interfaces presented to the healthcare representative. For example, information associated with available or approved services may be presented while information associated with other services that could potentially be performed is not presented. In this regard, the receipt of payment requests for non-covered services may be reduced and/or eliminated.

Either during a healthcare visit or following completion of a healthcare visit, information associated with provided or performed healthcare services may be communicated by the portable device 105 to the verification computer 110. The healthcare service information may then be provided to the service module 194 for evaluation, and the service module 194 may determine whether the provided services are covered by a healthcare payor. In the event that a service is covered, then the service module 194 may provide approval information to the claim module 198. If, however, a service is not covered, then the service module 194 may generate a suitable alert and/or rejection message that is communicated to one or more recipients, such as the portable device 105 and/or the healthcare provider. In certain embodiments, the service module 194 may perform additional processing in conjunction with a service that is not covered. For example, the service module 194 may evaluate one or more exception codes and/or reason codes included in received healthcare services information in order to determine whether the service can be covered. As another example, the service module 194 may escalate a services approval determination for manual review.

The verification module 196 may be a suitable software module or application that facilitates the evaluation of location verification information and/or timing information in order to verify whether a healthcare visit occurred at an approved patient location 125 and/or that the healthcare visit occurred during an expected or acceptable time frame. Additionally, in certain embodiments, the verification module 196 may be configured to initiate a “super session” with a portable device 105 and/or to provide session information (e.g., a session identifier, encryption information, etc.) to the portable device 105.

In one example operation, the verification module 196 may establish communication with a portable device 105, and the verification module 196 may authenticate the portable device 105. For example, the verification module 196 may evaluate authentication credentials (user name, password, etc.) entered into a service application 156 by a healthcare representative 115, service application information (e.g., a digital certificate, an application identifier, device identification information (e.g., a device identifier, a telephone number, a secure element identifier), and/or other information in order to determine whether the portable device 105 is a registered device. For example, a determination may be made as to whether the portable device 105 is registered with a healthcare provider and/or whether a user of the device (e.g., the healthcare representative 115) is registered to utilize the portable device 105 in association with healthcare visits. In the event that authentication is completed, the verification module 196 may direct the provision of a wide variety of information to the service application 156, such as patient information, appointment information, approved healthcare service information, and/or patient location information (e.g., GPS coordinates that may be processed by the service application while at a patient location). Additionally, in certain embodiments, the verification module 196 may facilitate the establishment of a “super session” with the service application 156, and a wide variety of session information (e.g., a session identifier, encryption information, etc.) may be communicated to the service application 156.

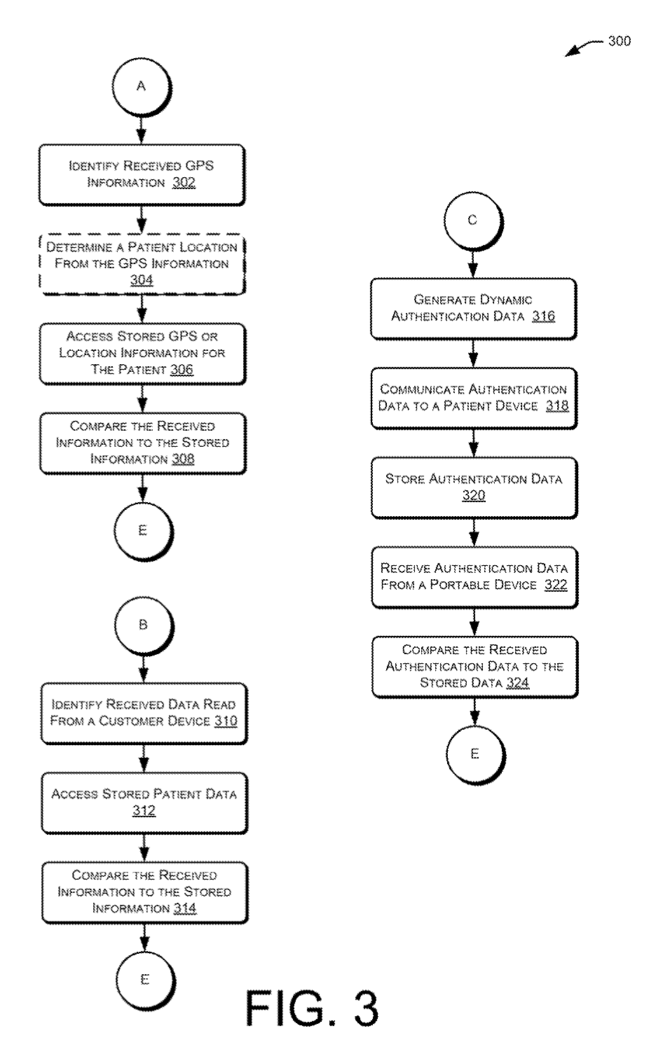

Additionally, the verification module 196 may receive a wide variety of different types of location verification information and/or timing information (e.g., time stamps, etc.) from the service application 156, either during a healthcare visit or subsequent to a healthcare visit. Examples of suitable location verification information that may be received include, but are not limited to, GPS coordinates, information collected from a patient device, and/or location exceptions (e.g., out of geo-fence exceptions, etc.). The verification module 196 may evaluate at least a portion of the location verification information in conjunction with timing information, such as time stamps associated with the location verification information, in order to determine whether a healthcare visit occurred and/or whether a healthcare visit occurred during an appropriate time frame. For example, received location verification information (e.g., GPS coordinates, information collected from a patient device, etc.) may be compared to stored location information and/or data (e.g., account data, etc.) associated with the patient in order to determine whether a healthcare visit occurred at an appropriate location. Additionally, received timing information may be compared to appointment information for the patient in order to determine whether a healthcare visit occurred during an appropriate period of time. As desired, a plurality of different received sets of information (e.g., location and timing information collected at the beginning of a visit, information collected at the end of the visit, and/or information collected at one or more points during the visit, etc.) may be evaluated. In this regard, a determination may be made as to whether the healthcare representative 115 remained at the patient location throughout an expected duration for the healthcare visit. A few examples of the verifications that may be performed by the verification module 196 are described in greater detail below with reference to FIG. 3.

In certain embodiments, the verification module 196 may additionally be configured to generate location verification information, such as dynamic encryption data (or an application that generates encryption data), that is communicated by the verification computers 110 to a patient device, such as a patient computer or patient mobile device 130D. As a result, a portable device 105 may interact with a patient device in order to collect the generated location verification information, and the portable device 105 may return the collected information to the verification computer 110. The verification module 196 may then compare the information received from the portable device 105 to a stored (or independently generated) copy of the location verification information in order to verify a healthcare visit.

As set forth above, GPS coordinates may be utilized to verify healthcare visits. For example, received GPS coordinates may be compared to stored location information for a patient. Additionally, in certain embodiments, one or more suitable location learning techniques and/or algorithms may be implemented by the verification module 196 in order to accurately determine parameters associated with a patient location (e.g., GPS coordinates, a geo-fence size, etc.). As an initial matter, when a patient is first identified, a patient address is typically utilized to identify initial geo-code information (e.g., latitude and longitude values) for the patient. For example, the patient address is provided to a third party for geo-coding purposes, and geo-code information is returned. However, the initial geo-code information is frequently inaccurate, and that the true coordinates of a patient location 125 cannot be easily identified. For example, the initial geo-code information may point to the geographic center of a zip code area associated with the patient location 125. Conventionally, users would typically be required to review the initial locations on a map and adjust the initial locations to correct coordinates associated with the patient location 125. This conventional process is typically labor-intensive and can be relatively costly.

Embodiments of the invention may implement a suitable learning algorithm in order to accurately identify GPS coordinates associated with a patient location 125. For example, an initial starting value received from a geo-code service or initial GAS coordinates collected during a healthcare visit may be identified as a starting point for a “learning” mode. As desired, an initial geo-fence area (e.g., an initial area of approximately ⅛ of a mile in either direction, etc.) may also be established. Further, in certain embodiments, geo-fence exceptions may be ignored or minimally processed while in the “learning” mode. Over time, as additional healthcare visits are performed, received sets of GPS coordinates may be combined with a staring point and/or with previously received GPS coordinates. For example, each new set of GPS coordinates may be averaged with previous coordinates in a weighted manner (e.g., an average weighted in accordance with the total number of coordinate sets received, etc.). Additionally, a standard deviation between the average coordinates (at the time new coordinates are received) and a new set of coordinates may be calculated in order to determine whether the GPS coordinates are converging towards a final value. Alternatively, a determination may be made as to whether the total. number of received coordinate sets satisfies a predetermined threshold (e.g., five sets of coordinates, ten sets of coordinates, etc.). In the event that it is determined that a final value is being converged upon and/or that a threshold has been reached, then relatively accurate coordinates for the patient location 125 may be identified and stored. Additionally, a suitable geo-fence size may be determined and stored. The “learning” mode may then be ended, and the stored coordinates may be utilized for visit verification purposes and/or for geo-fence exception purposes.

As desired, once a “learning mode” has ended, the verification module 196 may perform a wide variety of additional operations associated with evaluating a patient location 125. For example, patient location coordinates may continue to be refined based upon additional GPS coordinates that are received. As another example, repeated instances of services being performed outside of a geo-fence may result in a recalculation of a patient location 125. As yet another example, in the event that the same client address is referenced for services delivered in more than one location and/or if a relatively large geo-fence size has been determined, then the verification module 196 may determine whether two distinct patient locations 125 are being utilized and/or whether healthcare service distribution is bi-modal. Indeed, a wide variety of suitable operations may be performed as desired by the verification module 196 in order to evaluate and/or refine patient location data.

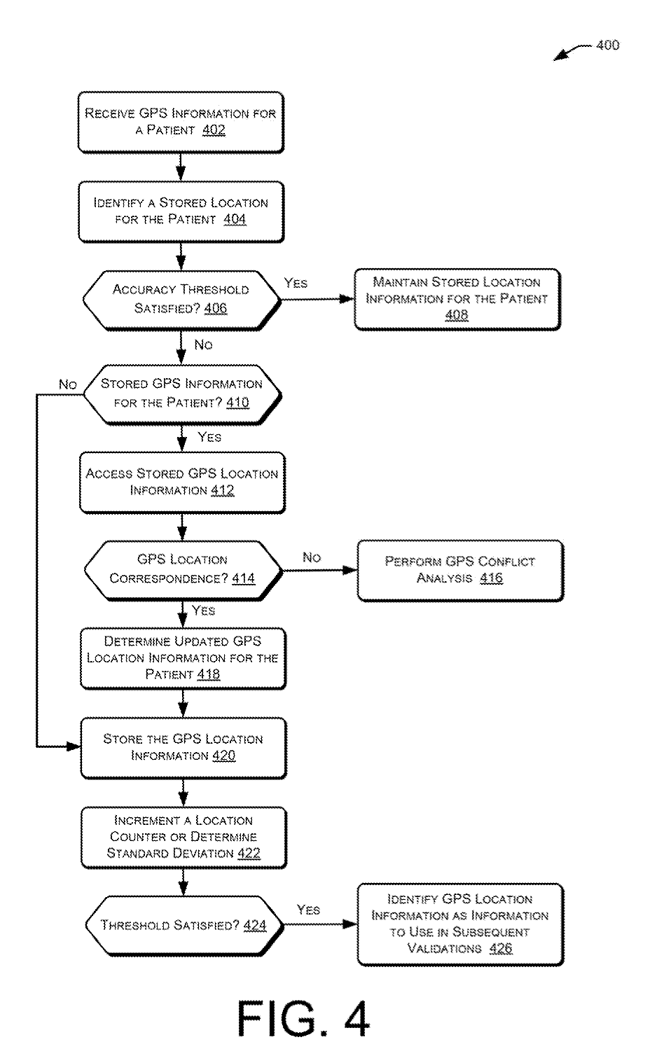

One example of the operations that may be performed to facilitate location learning for a patient is described in greater detail below with reference to FIG. 4; however, as set forth above, a wide variety of different techniques may be utilized to facilitate location learning.

The claim module 198 may be a suitable software module or application that facilitates the generation of healthcare claims associated with healthcare services performed at a patient location 125. For example, if it has been determined that a healthcare visit has occurred at an appropriate patient location and during an appropriate time period, then the claim module 198 may facilitate the generation of a healthcare claim transaction associated with one or more approved services performed during the healthcare visit. In certain embodiments, the claim module 198 may generate a healthcare claim transaction that will be submitted to a suitable claims processor (e.g., an insurance provider, a benefits manager, a government payor, etc.). In other embodiments, the claim module 198 may send an approval message to another system (e.g., a healthcare provider system, etc.) indicating that a claim should be generated. Once generated, a claim may be communicated to a claims processor, and the claim may be adjudicated by the claims processor. If approved, the claims processor may direct that a payment be made to a healthcare provider.

In certain embodiments, the verification computer 110 may additionally include a suitable messaging module configured to generate and/or communicate secure messages to the service applications of any number of portable devices 105. For example, messages generated by the verification computer 110 that include protected healthcare information may be communicated to a service application 156. As another example, messages received from a healthcare provider (or other entity) may be communicated to a service application 156. Additionally, in certain embodiments, the messaging module may be configured to communicate or direct the communication of one or more alert messages, such as SMS messages, to a portable device 105 in order to inform a healthcare representative user of the portable device 105 that one or more secure messages are available for access via the service application 156. As a result of the secure messaging facilitated by the messaging module, the privacy of protected healthcare information may be enhanced and/or maintained.

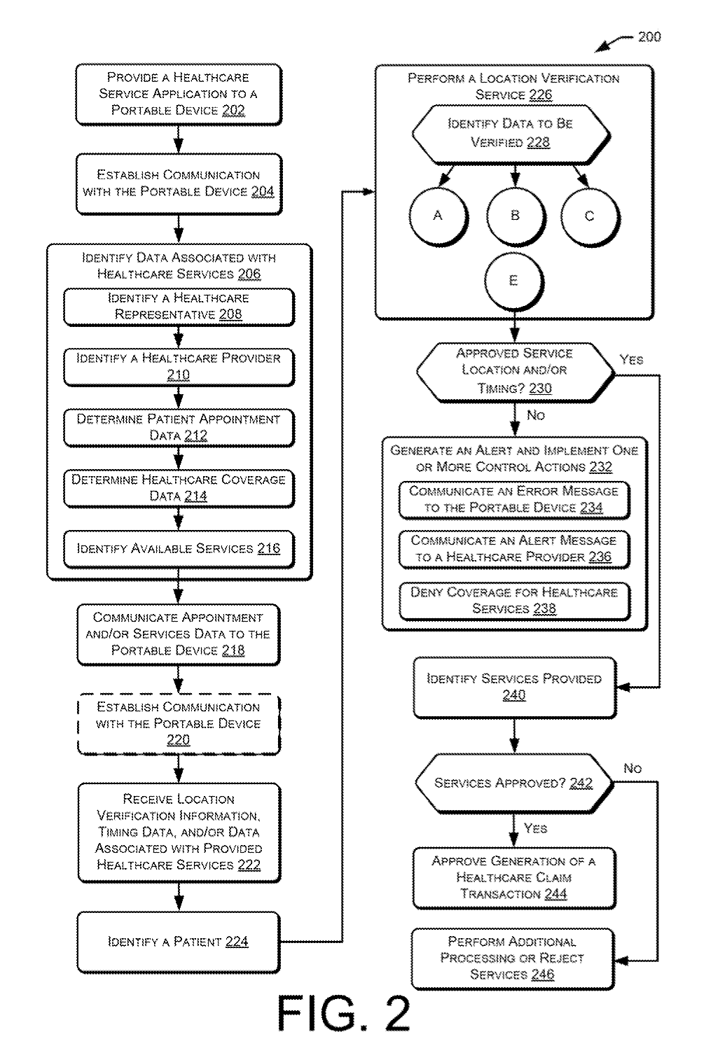

A few examples of the operations that may be performed by the verification computer 110 and/or the various modules and/or applications associated with the verification computer 110 are described in greater detail below with reference to FIGS. 2-4.

With continued reference to the verification computer 110, the one or more I/O interfaces 176 may facilitate communication between the verification computer 110 and one or more input/output devices; for example, one or more user interface devices, such as a display, a keypad, a mouse, a pointing device, a control panel, a touch screen display, a remote control, a microphone, a speaker, etc., that facilitate user interaction with the verification computer 110. The one or more communication interfaces 178 may facilitate connection of the verification computer 110 to one or more suitable networks, for example, the networks 120 illustrated in FIG. 1. In this regard, the verification computer 110 may receive and/or communicate information to other components of the system 100.

With continued reference to FIG. 1, any number of patient devices, such as the illustrated patient devices 130A-D, may be provided. Certain patient devices, such as a patient card 130B that includes a QR code that may be scanned or otherwise captured by a portable device 105 and/or a patient card 130C (or other device such as a fob, etc.) that includes a suitable communication element (e.g., a contactless RF chip or element, a contactless NFC chip, etc.), may be devices from which a wide variety of location verification information (e.g., a patient name, a patient healthcare account number, a patient verification code, etc.) may be extracted. Other patient devices, such as a mobile device 130D or a personal computer, may be suitable devices that interact with the portable device 105 in order to form a suitable communications session. In this regard, a wide variety of location verification information and/or authentication information (e.g., dynamic authentication information, etc.) may be communicated to a portable device 105. For example, authentication information or an application that generates authentication information may be received by a mobile device 130D from the verification computers 110. During a healthcare visit, authentication information may then be provided to the portable device 105 for use in visit verification services. As desired, certain patient devices may be processor-driven devices that include components similar to those described above for the portable device 105 and/or the verification computers 110. For example, certain patient devices may include one or more processors, memory devices, I/O interfaces, and/or network interfaces.

A wide variety of suitable networks 120 may be utilized in association with embodiments of the invention. These networks 120 may include any telecommunication and/or data network, whether public, private, or a combination thereof, including a local area network, a wide area network, an intranet, the Internet, intermediate handheld data transfer devices, a public-switched telephone network (“PSTN”), a cellular network, and/or any combination thereof and may be wired and/or wireless. Due to network connectivity, various methodologies as described herein may be practiced in the context of distributed computing environments. It will also be appreciated that the various networks may include a plurality of networks, each with devices such as gateways and routers for providing connectivity between or among networks. Additionally, instead of, or in addition to, a network, dedicated communication links may be used to connect various devices in accordance with an example embodiment.

Additionally, as desired in various embodiments, the healthcare representative 115 may utilize a telephone 130A situated at the patient location in order to dial in to a suitable verification service provider, such as an interactive voice response (“IVR”) system associated with the verification computers 110 and/or a service provider that facilitates visit verifications. For example, the healthcare representative 115 may utilize the telephone 130A to dial a verification telephone number (e.g., a toll free number, etc.) both at the beginning of a visit and at the end of the visit. A verification service provider that receives the calls may identify a DNIS and/or an ANI associated with the telephone 130A, and the verification service provider may compare the identified DNIS and/or ANI to stored information associated with the patient 135. Based at least in part upon the comparison, the verification service provider may then determine whether a healthcare visit should be verified. For example, in the event that a correspondence is found, the verification service provider may determine that a healthcare visit took place at an approved patient location. The verification service provider may additionally evaluate the call times in order to determine whether a healthcare visit occurred at an appropriate time or during an appropriate time window. For example, the call times may be compared to appointment information. It will be understood that the described dial-in service is optional. For example, the dial-in service may be utilized in conjunction with a verification service that involves the evaluation of data collected by a portable device 105.

The system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

Additionally, although the system 100 is described above as verifying the presence of a healthcare representative or other individual at a healthcare visit (e.g., a home healthcare visit, etc.), embodiments of the invention may be utilized in a wide variety of other operating environments in order to verify that services were performed at an appropriate location. For example, embodiments of the invention may be utilized to verify social services and/or social worker visits, parole officer visits, and/or a wide variety of other service visits.

Operational Overview

FIG. 2 illustrates a flow diagram of an example method 200 for providing a verification service in association with a healthcare visit, according to an example embodiment of the invention. In certain embodiments, the operations of the method 200 may be performed by a suitable verification system and/or verification computer, such as the verification computers 110 illustrated in FIG. 1. The method 200 may begin at block 202.

At block 202, a healthcare service application, such as the service application 156 described above with reference to FIG. 1, may be provided to a portable device, such as the portable device 105 described above with reference to FIG. 1. The service application 156 may facilitate a wide variety of different types of communications with the verification computers 110 that are associated with any number of healthcare visits. Additionally, a wide variety of suitable methods and/or techniques may be utilized to provide a service application 156 to a portable device 105. For example, the service application 156 may be provisioned (e.g., over the air (“OTA”) provisioning, etc.) to the portable device 105 by a suitable OTA system; downloaded to the portable device from the verification computers 110, a healthcare service provider system, or a third-party service provider (e.g., a service provider that hosts an application store, etc.); loaded on the portable device 105 from a removable storage device; provided to the portable device 105 from a suitable kiosk or other terminal; or otherwise provided to the portable device 105.

At block 204, communication between a verification computer 110 and the portable device 105 may be established. For example, a communications session may be established between the verification computer 110 and the service application 156. In certain embodiments, the communication may be established prior to any healthcare visits being performed by a user of the portable device 105, such as the healthcare representative 115 illustrated in FIG. 1. Additionally, in certain embodiments, the communications session may be established as a “super session” intended to remain active for a predetermined period of time, such as 18 hours or some other time period, regardless of the connectivity between the portable device 105 and the verification computer 110. In the event that a super session is established, information associated with the super session, such as a session identifier and/or encryption information that may be utilized to encrypt stored information, may be communicated to the service application 156 by the verification computer 110.

At block 206, data associated with one or more healthcare services and/or healthcare visits to be performed by the healthcare representative 115 may be identified and/or determined. A wide variety of suitable data may be identified and/or determined as desired in various embodiments of the invention. For example, at block 208, a healthcare representative 115 associated with the portable device 105 may be identified and authenticated. In one example embodiment, identification and/or authentication information (e.g., a user name and password, a digital certificate, etc.) received from the service application 156 may be evaluated in order to identify the healthcare representative 115 and to authenticate the healthcare representative. At block 210, a healthcare provider associated with the healthcare representative 115 may be identified or determined. For example, identification information for the healthcare representative 115 may be compared to stored information associated with representatives of various healthcare providers in order to identify a healthcare provider. As another example, identification information for the portable device 105 (e.g., a device identifier, a Media Access Control (“MAC”) address, an Internet Protocol (“IP”) address, a telephone number, a Mobile Subscriber Integrated Services Digital Network (“MSISDN”) number, an International Mobile Equipment Identity/Mobile Equipment Identifier (“IMEI/MEID”), etc.) may be received and compared to stored information associated with registered devices for a healthcare service provider in order to identify an applicable healthcare service provider.

At block 212, a wide variety of patient appointment data may be determined for the healthcare representative 115. For example, stored information associated with scheduled appointments for the healthcare representative 115 may be accessed from memory or obtained from one or more external data sources. As another example, scheduled patient appointments may be identified, and appointments may be assigned to the healthcare representative 115 based upon a wide variety of parameters, such as proximities of the healthcare representative 115 to various patients. As desired, a wide variety of different types of appointment data may be identified, including but not limited to, patient identification information, patient location information (e.g., a patient address, stored GPS coordinates, stored geo-fence information, etc.), and/or scheduled healthcare services to be performed at an appointment. Additionally, at block 214, healthcare coverage information and/or eligibility information (e.g., insurance coverage information, Medicare coverage and/or eligibility information, Medicaid coverage and/or eligibility, etc.) may be determined for one or more patients. In this regard, the healthcare services that are eligible for coverage and/or payment by one or more healthcare payors (e.g., insurance companies, government payors, etc.) may be determined. Accordingly, at block 216, available and/or approved healthcare services that may be performed by the healthcare representative 115 during a healthcare visit may be identified. For example, a list of one or more services offered by a healthcare provider may be identified, and the offered services may be compared to a list of one or more services covered by the applicable payors in order to identify one or more available and/or approved healthcare services that may be performed.

At block 218, at least a portion of the data associated with one or more healthcare services and/or healthcare visits that is identified at block 206 (or at sub-blocks 208-216) may be communicated to the portable device 105 and/or the service application 156. In this regard, the service application 156 may generate a wide variety of suitable interfaces and/or presentations that may be presented to the healthcare representative 115. For example, one or more presentations associated with upcoming appointments and/or healthcare services that may be performed at the appointments may be presented to the healthcare representative.

Following the provision of data to the portable device 105 at block 218, the healthcare representative may utilize the portable device 105 and/or the service application 156 to collect location verification information, timing information, and/or provided healthcare services information at any number of patient locations 125. It is possible that connectivity between the portable device 105 and the verification computer 110 will be lost as the portable device 105 is carried by the healthcare representative 115 to various locations. Accordingly, at block 220, which may be optional in various embodiments of the invention, communication with the portable device 105 may be reestablished either at a patient location or following a healthcare visit. As desired, the loss of connectivity and the reestablishment of communication may not affect a super session that has been established between the verification computer 110 and the service application 156.

At block 222, a wide variety of information associated with healthcare visits may be received from the portable device 105. In certain embodiments, information may be received while the portable device 105 is located at a patient location 125. In other embodiments, information stored by the portable device 105 at one or more patient locations may be received. Examples of suitable information that may be received include, but are not limited to, patient identification information, location verification information (e.g., GPS coordinates, geo-fence exceptions, information collected from or received from a patient device, etc.), timing information (e.g., time stamps associated with location verification information, etc.), and/or data associated with any number of healthcare services performed during healthcare visits.

At block 224, a patient associated with an identified healthcare visit may be identified or determined. For example, received patient identification information may be utilized to identify a patient. As another example, stored appointment data associated with a healthcare visit may be evaluated in order to identify a patient. Once the patient is identified, a wide variety of information associated with the patient may be obtained, such as stored patient location information, stored information associated with patient devices (e.g., account information, QR code information, etc.), and/or stored patient healthcare coverage information. At least a portion of the obtained information associated with the patient may be utilized to perform a location verification service arid/or to determine whether performed healthcare services are approved or covered services.

At block 226, a location verification service may be performed. The location verification service may evaluate a wide variety of different types of received location verification information and compare the location verification information to stored (or independently received) location information for the identified patient. Examples of suitable location verification information that may be evaluated include, but are not limited to, GPS coordinates, information collected from a patient device (e.g., account data, authentication codes, QR codes, etc., and/or information received by a portable device during a communications session with a patient device (e.g., authentication information, dynamic authentication information, etc.). At block 228, one or more types of received location verification information may be identified or determined. A suitable evaluation process may then be performed for each of the one or more types of received location verification information. A few examples of evaluation processes that may be performed are described in greater detail below with reference to FIG. 3.

Additionally, at block 226, received timing information associated with a healthcare visit may be evaluated. For example, time stamp information associated with one or more sets of location verification information may be identified, such as time stamp information associated with location verification information collected at the start of a healthcare visit, time stamp information associated with location verification information collected at the end of a healthcare visit, and/or time stamp information associated with location verification information collected at any point during the healthcare visit (e.g., GPS coordinates periodically collected throughout the visit, geo-fence data periodically collected throughout the visit, etc.). The timing information may then be compared to expected timing information associated with a patient appointment, and a determination may be made as to whether the timing information corresponds to the expected timing information and/or whether any deviations fall within acceptable parameters and/or thresholds.

At block 230, a determination may be made as to whether a healthcare visit occurred at an approved service location. For example, a determination may be made as to whether received location verification information corresponds to stored information associated with a patient location. Additionally, a determination may be made as to whether a healthcare visit occurred within an acceptable time frame. For example, a determination may be made as to whether timing information associated with a healthcare visit corresponds to expected timing information. If it is determined at block 230 that a healthcare visit did not occur at an approved service location and/or within an approved or expected time frame, then operations may continue at block 232. At block 232, the verification computer 110 may generate an alert associated with the determination, and the verification computer 110 may implement any number of suitable control actions. For example, at block 234, an error message (e.g., a message indicating that a healthcare visit has not been verified, etc.) may be generated and communicated to the portable device 105. As desired, a response to the message may be received from the portable device 105 and processed in order to determine whether the healthcare visit should be verified. As another example, at block 236, an alert message may be generated and communicated to a healthcare provider associated with the healthcare representative 115. In this regard, the healthcare provider may take corrective action with respect to the healthcare representative. As yet another example, at block 238, coverage for one or more healthcare services purportedly performed during the healthcare visit may be denied or placed in a holding state until additional information is received. The described control actions are provided by way of example only, and it will be appreciated that other suitable control actions may be performed as desired in various embodiments of the invention.

If, however, it is determined at block 230 that a healthcare visit occurred at an approved service location and/or within an approved or expected time frame, then operations may continue at block 240. At block 240, one or more healthcare services performed during the healthcare visit may be identified. For example, one or more performed healthcare services may be identified based upon an evaluation of information received from the portable device 105. At block 242, a determination may be made as to whether the identified services are approved services that are covered by one or more healthcare payors (e.g., an insurance provider, a government payor, etc.) associated with the patient. If it is determined at block 242 that the one or more healthcare services are approved or covered services, then operations may continue at block 244. At block 244, the generation of a healthcare claim transaction associated with the provided healthcare services may be approved. A healthcare claim transaction may then be generated (e.g., generated by a healthcare provider, generated by the verification computer 110, etc.) and communicated to a claims processor (e.g., an insurance provider, a government payor, etc.) for adjudication.

If, however, it is determined at block 242 that the one or more healthcare services are not approved or covered services, then operations may continue at block 246. At block 246, a wide variety of additional processing may be performed in association with one or more healthcare services that are determined to be unapproved or not covered. For example, a message providing an indication of the unapproved service(s) may be communicated to the portable device 105 along with a request for service explanations. One or more explanations and/or reason codes associated with the services may then be received and evaluated in order to determine whether one or more of the services may be covered. As an alternative to performing additional processing at block 246, a rejection for the services that are not approved or covered may be generated.

The method 200 may end following either block 244 or block 246.

FIG. 3 illustrates flow diagrams of example methods 300 for performing a location verification for a healthcare visit, according to an example embodiment of the invention. The operations illustrated in FIG. 3 are examples of operations that may be performed at block 226 illustrated in FIG. 2 in association with a location verification service. As such, the methods 300 may be performed by a suitable verification system and/or verification computer, such as the verification computers 110 illustrated in FIG. 1. The methods 300 will now be separately described.

With reference to a first example method, GPS information may be received and evaluated in order to conduct a location verification analysis. At block 302, which may be reached from block 228 of FIG. 2, a wide variety of received GPS information may be identified, such as one or more sets of GPS coordinates and/or information associated with one or more geo-fence exceptions identified by the portable device 105. In certain embodiments, a plurality of sets of GPS coordinates associated with a healthcare visit may be received, such as coordinates collected at the beginning of a healthcare visit, coordinates collected upon completion of a healthcare visit, and/or any number of sets of coordinates collected during the healthcare visit (e.g., periodically collected coordinates, etc.).

At block 304, which may be optional in certain embodiments of the invention, a patient location may be determined from received GPS information. For example, received GPS information may be utilized to determine an address. At block 306, stored GPS and/or location information (e.g., a stored patient address, etc.) for the patient may be accessed from memory and/or obtained from one or more suitable data sources. At block 308, at least a portion of the received information (and/or determined patient location) may be compared to at least a portion of the accessed information. In this regard, a determination may be made as to whether GPS information collected by the portable device 105 (and/or a location determined from the GPS information) corresponds to stored GPS and/or location information for the patient. For example, a determination may be made as to whether a match is identified. As another example, a determination may be made as to whether any differences between the two sets of information fall within a geo-fence area and/or satisfy one or more suitable tolerance thresholds. In certain embodiments, a plurality of sets of received GPS information may be evaluated, such as respective GPS information associated with different points in time for the healthcare visit. As a result of the comparison(s) performed at block 308, a determination may be made as to whether a healthcare visit occurred at an approved patient location.

As desired in various embodiments, one or more geo-fence exceptions may also be identified and/or evaluated. In this regard, a determination may be made as to whether a healthcare representative remained at a patient location 125 for the duration of a healthcare visit. Additionally, a determination may be made as to whether additional processing should be performed, such as a reevaluation of stored location information for the patient, a determination of whether a geo-fence area should be modified, or a determination of whether two separate patient locations should be identified.

Following block 308, operations may then continue at block 230 of FIG. 2.

With reference to a second example method, information collected by a portable device 105 from a patient device may be received and evaluated in order to conduct a location verification analysis. At block 310, which may be reached from block 228 of FIG. 2, a wide variety of received data read by a portable device 105 from one or more patient devices may be identified. For example, account information and/or authentication information collected from a patient card or other patient device via RF and/or NEC communication (e.g., a tap of a patient card to the portable device 105, etc.) may be identified. As another example, a QR code captured from a patient card or other patient device by the portable device 105 may be identified. Other examples of information that may be collected from a patient device 105 will be appreciated.

At block 312, stored patient data (e.g., stored data associated with information stored by patient devices, stored QR code information, stored account information, stored authentication information, etc.) may be accessed from memory and/or obtained from one or more suitable data sources. At block 314, at least a portion of the received information may be compared to at least a portion of the accessed information. In this regard, a determination may be made as to whether the information collected by the portable device 105 corresponds to stored information for the patient. For example, a determination may be made as to whether a collected QR code matches a stored QR code. As another example, a determination may be made as to whether collected authentication information matches stored authentication information. In certain embodiments, a plurality of sets of received information may be evaluated, such as information associated with different points in time for the healthcare visit. As a result of the comparison(s) performed at block 314, a determination may be made as to whether a healthcare visit occurred at an approved patient location.

Following block 314, operations may then continue at block 230 of FIG. 2.

With reference to a third example method, information received by a portable device 105 during a communications session with a patient device may be received and evaluated in order to conduct a location verification analysis. At block 316, which may be reached from block 228 of FIG. 2, authentication data, such as a dynamic authentication code or other authentication data (e.g., a digital certificate, an authentication key, etc.), may be generated by the verification computers 110. Alternatively, a suitable application or program module configured to generate authentication data may be identified. At block 318, the generated authentication data and/or authentication application may then be communicated by the verification computer 110 (or another system) to a patient device, such as a patient computer or a patient mobile device. Additionally, the authentication data (and/or a copy of an authentication application) may be stored by the verification computer 110 at block 320.

During a healthcare visit, a healthcare representative 115 may utilize a portable device 105 to establish communication with the patient device. During an established communications session, one or more sets of authentication data (e.g., one or more sets of dynamic authentication data, etc.) may be communicated by the patient device to the portable device. As desired, the various data may be time stamped by the patient device and/or by the portable device 105. The portable device 105 may then communicate at least a portion of the received authentication data to the verification computers 110, and the verification computers 110 may receive the authentication data at block 322. At block 324, the verification computers 110 may compare at least a portion of the received data to at least a portion of the stored authentication data (and/or independently generated authentication data). In this regard, a determination may be made as to whether the authentication data collected by the portable device 105 corresponds to stored authentication data for the patient. In certain embodiments, a plurality of sets of received authentication data may be evaluated, such as information associated with different points in time for the healthcare visit. As a result of the comparison(s) performed at block 324, a determination may be made as to whether a healthcare visit occurred at an approved patient location.

Following block 324, operations may then continue at block 230 of FIG. 2.

FIG. 4 illustrates a flow diagram of an example method 400 for identifying a location associated with a patient, according to an example embodiment of the invention. In certain embodiments, the operations of the method 400 may be performed by a suitable verification system and/or verification computer, such as the verification computers 110 illustrated in FIG. 1. The method 400 may begin at block 402.

At block 402, GPS information for a patient or a patient location may be received from a portable device, such as the portable device 105 described above with reference to FIG. 1. For example, GPS information collected by the portable device 105 during a healthcare visit may be received. At block 404, a stored location associated with the patient may be determined and/or accessed. For example, a stored address and/or stored GPS information for the patient may be identified and/or accessed. At block 406, a determination may be made as to whether an accuracy threshold is satisfied by the determined patient location. For example, a determination may be made as to whether stored geo-code information associated with a patient location satisfies an accuracy threshold. As another example, a determination may be made as to whether a “learning” mode associated with determining a patient location is in effect. If it is determined at block 406 that an accuracy threshold is satisfied, then operations may continue at block 408, and the stored location information for the patient may be maintained or determined to be accurate information. If, however, it is determined at block 406 that an accuracy threshold has not been satisfied, then operations may continue at block 410.

At block 410, a determination may be made as to whether stored GPS information (e.g., stored GPS coordinates, etc.) for the patient is available. For example, a determination may be made as to whether one or more previous sets of GPS coordinates have been received and processed. If it is determined at block 410 that stored GPS information is not available, then operations may continue at block 420 described in greater detail below. If, however, it is determined at block 410 that stored GPS information is available, then operations may continue at block 412, and the stored GPS information may be accessed.

At block 414, a determination may be made as to whether the received GPS information corresponds to the accessed GPS information. For example, a determination may be made as to whether the received GPS information matches the accessed GPS information or whether differences between the two sets of information exceed one or more thresholds (e.g., distance thresholds, tolerance levels, etc.). If it is determined at block 414 that the received GPS information does not correspond to the accessed GPS information, then operations may continue at block 416. At block 416, a wide variety of suitable GPS conflict analyses may be performed. For example, a determination may be made as to whether a patient has moved. As another example, an identified conflict may be escalated to a technician or other user to be resolved.

If, however, it is determined at block 414 that the received GPS information corresponds to the accessed GPS information, then operations may continue at block 418. At block 418, updated GPS location information, such as updated GPS coordinates, may be determined for the patient or patient location. For example, the received GPS information may be averaged with the accessed GPS information. In certain embodiments, a weighting averaging may be performed. For example, a greater weight may be provided to the accessed information in the event that the accessed information was determined from a plurality of sets of previously received GPS information. As desired, the weighting may be determined based at least in part upon the number of previously received sets of GPS information. As a result of determined updated GPS location information, a relatively accurate location for the patient may be determined over time as healthcare visits are performed.

At block 420, which may be reached from either block 410 or block 418, the GPS location information may be stored for subsequent access. At block 422, a counter associated with a number of received sets of GPS location information may be incremented. Additionally or alternatively, a standard deviation between the received GPS information and the accessed GPS information may be determined and/or evaluated. At block 424, a determination may be made as to whether one or more suitable thresholds associated with establishing location information for the patient and/or with exiting a “learning” mode have been satisfied. For example, a determination may be made as to whether the counter satisfies a threshold counter value associated with a desired number of sets of GPS location information. As another example, a determination may be made as to whether the standard deviation is lower than a suitable threshold indicating that received sets of GPS location information are converging on a common location. If it is determined at block 424 that the one or more thresholds have not been satisfied, then operations may end and a “learning” mode may be continued. If, however, it is determined at block 424 that the one or more thresholds have been satisfied, then operations may continue at block 426, and the updated GPS location information may be identified as location information to be utilized in association with the patient for subsequent healthcare visit verifications. As desired, a “learning” mode may be exited. Additionally, in certain embodiments, a suitable geo-fence associated with identified GPS coordinates may be determined and stored.

The method 400 may end following either block 408, block 416, block 424, or block 426.

FIG. 5 illustrates a flow diagram of an example method 500 for collecting and processing healthcare visit information by a portable device, according to an example embodiment of the invention. In certain embodiments, the operations of the method 500 may be performed by a suitable portable device and one or more associated service applications, such as the portable device 105 and/or service applications 156 illustrated in FIG. 1. The method 500 may begin at block 502.

At block 502, a healthcare service application, such as the service application 156 described above with reference to FIG. 1, may be received from a suitable service provider by a portable device, such as the portable device 105 described above with reference to FIG. 1. The service application 156 may facilitate a wide variety of different functionality associated with healthcare visits and/or the verification of healthcare visits. As desired, a wide variety of suitable methods and/or techniques may be utilized to receive a service application 156. For example, the service application 156 may be received via a suitable provisioning communication, the service application may be downloaded from a service provider (e.g., a verification computer 110, a healthcare service provider system, a third-party service provider system, etc.), the service application 156 may be received from a removable storage device, or the service application 156 may be received from a suitable kiosk or other terminal.

At block 504, the service application 156 may be activated by the portable device 105, and the service application 156 may be utilized to establish communication with a verification system, such as a verification system that includes one or more verification computers 110. In certain embodiments, the communication may be established prior to any healthcare visits being performed by a user of the portable device 105, such as the healthcare representative 115 illustrated in FIG. 1. Additionally, in certain embodiments, the communications session may be established as a “super session” intended to remain active for a predetermined period of time, such as 18 hours or some other time period, regardless of the connectivity between the portable device 105 and the verification computer 110. In the event that a super session is established, information associated with the super session, such as a session identifier and/or encryption information that may be utilized to encrypt stored information, may be received by the service application 156 from the verification computer 110.

At block 506, a wide variety of data associated with one or more healthcare services and/or healthcare visits to be performed may be received by the portable device 105 or the service application 156. For example, at block 508, a wide variety of patient appointment data may be received, such as patient identification information, patient location information (e.g., a patient address, stored GPS coordinates, stored geo-fence information, etc.), and/or scheduled healthcare services to be performed at an appointment. As another example, at block 510, a wide variety of information associated with available and/or approved healthcare services that may be performed by the healthcare representative 115 during a healthcare visit may be identified. For example, a list of one or more services for which healthcare coverage is provided may be received. As desired, the service application 156 may utilize at least a portion of the received data in order to provide one or more suitable interfaces and/or presentations to the healthcare representative 115 via the portable device.

At block 512, the portable device 105 may be taken or carried to a patient location, such as the patient location 125 illustrated in FIG. 1, by the healthcare representative. The service application 156 may then be activated or invoked at the patient location 125. At block 514, the service application 156 may attempt to establish communication with the verification system. For example, the service application 156 may attempt to establish communication via a cellular network, a mobile network, or via any number of other suitable networks. In certain embodiments, a type of location verification information that is collected by the service application 156 may be determined based at least in part upon whether communication with the verification system can be established. For example, if it is determined at block 516 that communication can be established, then operations may continue at block 518, and GPS information may be collected for evaluation. If, however, it is determined at block 516 that communication cannot be established, then operations may continue at block 528, and verification information may be collected from a patient device 105 for evaluation. Although two verification options are described with reference to block 516, it will be appreciated that other verification options may be utilized. For example, in the event that a satellite connection may be established while a mobile connection with the verification system cannot be established, then GPS information may be collected for evaluation. As another example, both GPS information and information from a patient device may be collected.

At block 518, GPS information associated with a location of the portable device 105 may be determined. For example, communication may be established with one or more GPS satellites, and GPS coordinates associated with the portable device 105 may be determined. As desired, GPS coordinates may be determined at a wide variety of points in time during a healthcare visit. For example, GPS coordinates may be determined at the beginning of a healthcare visit, at the end of the healthcare visit, and/or at a wide variety of points in time (e.g., at predetermined intervals, etc.) during a healthcare visit. As desired, timing information associated with the various GPS coordinates, such as time stamps, may additionally be determined by the service application 156. Additionally, information associated with one or more healthcare services performed during the healthcare visit may be determined.

At block 520, at least a portion of the collected information may be communicated to the verification system during an established communications session. For example, collected information may be communicated in real-time or near real-time as the information is collected and/or determined. As another example, collected information may be periodically communicated to the verification system. A wide variety of different types of information may be communicated to the verification system utilizing any number of suitable communications. For example, at block 522, GPS information and/or timing information may be communicated to the verification system prior to any healthcare services being performed. As another example, at block 524, information associated with performed healthcare services may be communicated to the verification system either periodically or as the data is collected. Additionally, as desired, GPS information may be communicated to the verification system either periodically or in conjunction with services information. As another example, at block 526, GPS information and/or timing information may be communicated to the verification system at the end of the healthcare visit and/or following the performance of the healthcare services. As described in greater detail above with reference to FIGS. 2 and 3, the verification system may evaluate at least a portion of the communicated information in order to provide a healthcare visit verification service. Operation may then end following block 520 or any of blocks 522, 524, or 526.

At block 528, which may be reached from block 516, location verification information may be collected by the portable device 105 from any number of suitable patient devices, such as a patient card, a patient computer, and/or a patient mobile device. A wide variety of different types of verification information may be collected as desired in various embodiments of the invention. For example, at block 530, account information and/or other information may be read from a patient device (e.g., a patient card) via RF, NFC, or other suitable communication techniques. As another example, at block 532, optical data (e.g., an image) may be captured from a patient device, and the optical data may be processed in order to determine a QR code or other information associated with the patient device. As yet another example, at block 534, a communications session may be established between the portable device 105 and a patient device (e.g., a patient mobile device, a patient tablet computer, a patient computer, a patient fob, etc.), and a wide variety of verification information (e.g., authentication information, dynamic authentication information, account information, etc.) may be received from the patient device. Regardless of the types of verification information that is collected, as desired in various embodiments, a plurality of sets of verification information may be collected. For example, verification information may be collected prior to the provision of healthcare services (e.g., at the start of a healthcare visit) and after the provision of healthcare services (e.g., at the end of the healthcare visit). Additionally, as desired, collected verification information may be time stamped by the service application 156.

At block 536, a wide variety of timing information may be identified and/or collected by the service application 156. For example, respective time stamp information associated with the collected verification information may be identified. Additionally, at block 538, information associated with one or more performed or provided healthcare services may be identified. For example, one or more interfaces provided by the service application 156 may be utilized to collect information associated with performed healthcare services. As desired, other types of information associated with a healthcare visit may also be collected and/or determined.

At block 540, at least a portion of the collected information may be stored by the portable device 105 for subsequent communication to the verification system. For example, the collected location verification information, timing information, and/or healthcare service information may be stored. In certain embodiments, the collected information may be stored in a secure manner. For example, the collected information may be encrypted prior to storage. In certain embodiments, encryption information associated with a previously established “super session” may be utilized to encrypt the collected information prior to storage. In other embodiments, other encryption information, such as encryption information generated by the service application 156, may be utilized to encrypt the collected information. As another example of storing collected information in a secure manner, collected information may be stored in one or more secure elements (e.g., secure integrated circuit chips, etc.) associated with the portable device 105. As a result of storing information in a secure manner, private healthcare information may be protected and/or safeguarded.

At block 542, the portable device 105 and/or the service application 156 may attempt to establish communication with the verification system. For example, a periodic attempt may be made to establish communication with the verification system. As another example, an attempt to establish communication with the verification system may be made based upon an identification of available mobile service or cellular service. At block 544, a determination may be made as to whether communication is established with the verification system. If it is determined at block 544 that communication is established, then operations may continue at block 546, and at least a portion of the stored information may be communicated to the verification system for analysis. Additionally, as desired, the stored information may be deleted from the portable device 105. If, however, it is determined at block 544 that communication is not established with the verification system, then operations may continue at block 548.

At block 548, a determination may be made as to whether one or more timing thresholds associated with the local storage of healthcare information on the portable device 105 has been satisfied. For example, a determination may be made as to whether a super session has expired. As another example, a determination may be made as to whether the storage time for the stored information has exceeded a timing threshold. If it is determined at block 548 that one or more timing thresholds have not been satisfied or reached, then operations may continue at block 542 discussed above, and a subsequent attempt to establish communication with the verification system may be made. If, however, it is determined at block 548 that one or more timing thresholds have been satisfied or reached, then operations may continue at block 550.

At block 550, a wide variety of suitable actions may be taken by the service application 156 in order to protect or safeguard the previously stored information. For example, at least a portion of the stored information may be deleted. As another example, access to the stored information may be locked until suitable authentication credentials are entered into or received by the portable device 105 (e.g., provided by the healthcare representative, received from the verification system, etc.). Additionally, as desired, the service application 156 may provide suitable screen lock functionality. For example, if the service application 156 remains open on the portable device 105 for a predetermined period of time (e.g., 10 minutes, etc.) without healthcare representative interaction, then a screen or other display associated with the portable device 105 may be locked until suitable authentication credentials (e.g., a user name and password) are entered and verified.

The method 500 may end following either block 520, block 546, or block 550.

The operations described and shown in the methods 200, 300, 400, 500 of FIGS. 2-5 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 2-5 may be performed.

The invention is described above with reference to block and flow diagrams of systems, methods, apparatuses, and/or computer program products according to example embodiments of the invention. it will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

Various block and/or flow diagrams of systems, methods, apparatus, and/or computer program products according to example embodiments of the invention are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special purpose, hardware-based computer systems that perform the specified functions, elements or steps, or combinations of special purpose hardware and computer instructions.

Many modifications and other embodiments of the invention set forth herein will be apparent having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A computer-implemented method for verifying healthcare visits, the method comprising:
receiving, by a verification system comprising one or more computers from a portable device associated with an individual directed to provide a healthcare service to a patient during a healthcare visit, location verification information collected by the portable device;
comparing, by the verification system, at least a portion of the received information to stored information associated with the patient; and
determining, by the verification system based at least in part upon the comparison, whether the healthcare visit was performed at a service location for the patient.

2. The computer-implemented method of claim 1, wherein receiving location verification information comprises receiving first location verification information collected by the portable device prior to the healthcare service being provided and second location verification information collected by the portable device following provision of the healthcare service.

3. The computer-implemented method of claim 2, further comprising:
receiving, by the verification system from the portable device, first timing information collected by the portable device prior to the healthcare service being provided and second timing information collected by the portable device following provision of the healthcare service; and
determining, by the verification system based at least in part upon an analysis of the first timing information and the second timing information, whether the healthcare visit was performed during an approved time period.

4. The computer-implemented method of claim 1, wherein receiving location verification information comprises receiving global positioning system (GPS) coordinates, and
wherein comparing at least a portion of the received information to stored information comprises comparing the received GPS coordinates to stored GPS coordinates associated with a location of the patient.

5. The computer-implemented method of claim 4, wherein the GPS coordinates comprise first GPS coordinates, and further comprising:
receiving, by the verification system prior to receiving the first GPS coordinates, one or more sets of additional GPS coordinates; and
processing, by the verification system, the additional GPS coordinates in order to determine the stored GPS coordinates.

6. The computer-implemented method of claim 1, wherein receiving location verification information comprises receiving information captured by the portable device from a patient device.

7. The computer-implemented method of claim 6, wherein receiving location verification information comprises receiving at least one of (i) information captured by the portable device from an image of the patient device or (ii) information captured by the portable device via radio frequency communication with the patient device, or (iii) information captured by the portable device via near field communication with the patient device.

8. The computer-implemented method of claim 1, further comprising:
communicating, by the verification system to the portable device, at least one of (i) appointment information for the patient or (ii) information associated with one or more healthcare services approved for provision to the patient.

9. The computer-implemented method of claim 1, further comprising:
receiving, by the verification system from the portable device, information associated with the healthcare service provided to the patient; and
approving, by the verification system if it is determined that the healthcare visit was performed at the service location, generation of a healthcare claim transaction associated with the healthcare service.

10. A system for verifying healthcare visits, the system comprising:
at least one memory device configured to store computer-executable instructions; and
at least one processor configured to access the at least one memory device and execute the computer-executable instructions to:
receive, from a portable device associated with an individual directed to provide a healthcare service to a patient during a healthcare visit, location verification information collected by the portable device;
compare at least a portion of the received information to stored information associated with the patient; and
determine, based at least in part upon the comparison, whether the healthcare visit was performed at a service location for the patient.

11. The system of claim 10, wherein the received location information comprises first location verification information collected by the portable device prior to the healthcare service being provided and second location verification information collected by the portable device following provision of the healthcare service.

12. The system of claim 11, wherein the at least one processor is further configured to execute the computer-executable instructions to:
receive, from the portable device, first timing information collected by the portable device prior to the healthcare service being provided and second timing information collected by the portable device following provision of the healthcare service; and
determine, based at least in part upon an analysis of the first timing information and the second timing information, whether the healthcare visit was performed during an approved time period.

13. The system of claim 10, wherein the location verification information comprises at least one of (i) global positioning system (GPS) coordinates collected by the portable device or (ii) information captured by the portable device from a patient device.

14. The system of claim 10, wherein the at least one processor is further configured to execute the computer-executable instructions to:
receive, from the portable device, information associated with the healthcare service provided to the patient; and
approve, if it is determined that the healthcare service was performed at the service location, generation of a healthcare claim transaction associated with the healthcare service.

15. One or more computer-readable media storing computer-executable instructions that, when executed by at least one processor, configure the at least one processor to perform operations comprising:
identifying location verification information on behalf of a portable device carried by an individual who provides a healthcare service to a patient during a healthcare visit; and
directing communication of the location verification information to a verification system,
wherein the verification system evaluates at least a portion of the location verification information to determine whether the healthcare visit was performed at the approved service location for the patient.

16. The computer-readable media of claim 15, wherein the computer-executable instructions further configure the at least one processor to perform operations comprising:
determining that a network connection between the portable device and the verification system can be established,
wherein identifying location verification information comprises collecting global positioning system (GPS) coordinates, and
wherein the verification system compares the GPS coordinates to stored location information associated with the patient.

17. The computer-readable media of claim 15, wherein the computer-executable instructions further configure the at least one processor to perform operations comprising:
determining that a network connection between the portable device and the verification system cannot be established,
wherein identifying location verification information comprises collecting information from a patient device, and
wherein directing communication of the location verification information comprises directing communication once it is determined that a network connection can be established.

18. The computer-readable media of claim 17, wherein the information collected from a patient device comprises at least one of (i) information captured from an image of the patient device or (ii) information captured via radio frequency communication with the patient device, or (iii) information captured via near field communication with the patient device.

19. The computer-readable media of claim 15, wherein the computer-executable instructions further configure the at least one processor to perform operations comprising:
receiving, from the verification server, at least one of (i) appointment information for the patient or (ii) information associated with one or more healthcare services approved for provision to the patient.

20. The computer-readable media of claim 15, wherein the computer-executable instructions further configure the at least one processor to perform operations comprising:
collecting information associated with the healthcare service provided to the patient; and
communicating, to the verification service if it is determined that a network connection between the portable device and the verification system can be established, the collected healthcare service information; or
directing, if it is determined that a network connection between the portable device and the verification system cannot be established, encrypted storage of the collected healthcare service information on the portable device.

21. The computer-readable media of claim 20, wherein the healthcare service information is stored on the portable device, and wherein the computer-executable instructions further configure the at least one processor to perform operations comprising:
monitoring a period of time in which the healthcare service information is stored on the portable device;
determining that the monitored period of time exceeds a predetermined time threshold; and
directing a control action based at least in part upon the determination, the control action comprising at least one of (i) locking access to the stored healthcare service information on the portable device, or (ii) directing deletion of the stored healthcare service information.

22. A portable device associated with an individual who provides a healthcare service to a patient during a healthcare visit, the portable device comprising:
at least one memory device configured to store computer-executable instructions; and
at least one processor configured to access the at least one memory device and execute the computer-executable instructions to:
identify location verification information on behalf of the portable device; and
direct communication of the location verification information to a verification system,
wherein the verification system evaluates at least a portion of the location verification information to determine whether the healthcare visit was performed at an approved service location for the patient.

23. The portable device of claim 22, wherein the at least one processor is further configured to execute the computer-executable instructions to:
determine that a network connection between the portable device and the verification system can be established; and
collect global positioning system (GPS) coordinates as the identified location verification information,
wherein the verification system compares the GPS coordinates to stored location information associated with the patient.

24. The portable device of claim 22, wherein the at least one processor is further configured to execute the computer-executable instructions to:
determine that a network connection between the portable device and the verification system cannot be established;
collect information from a patient device as the identifying location verification information; and
direct communication of the location verification information to the verification system once it is determined that a network connection can be established.
